(19) United States
(12) Patent Application Publication
(10) Pub. No.: US 2026/0216641 A1
(43) Pub. Date: Jul. 30, 2026

(54) WASTE-HEAT RECOVERY SYSTEM FOR CARBON CAPTURE

(71) Applicant: Valero Services, Inc., San Antonio, TX (US)

(72) Inventors: Terrence F. Alger, II, San Antonio, TX (US); Graham Thomas Conway, San Antonio, TX (US)

(73) Assignee: Valero Services, Inc., San Antonio, TX (US)

(21) Appl. No.: 19/387,012

(22) Filed: Nov. 12, 2025

Related U.S. Application Data
(60) Provisional application No. 63/749,759, filed on Jan. 27, 2025.

(51) Int. Cl. B01D 53/34; B01D 53/62; F28D 21/00

(52) U.S. Cl. CPC B01D 53/343; B01D 53/346; B01D 53/62; F28D 21/0014; B01D 2257/504; B01D 2258/01; B01D 2259/4566

(57) ABSTRACT

The present disclosure provides integrated systems and methods that combine waste heat recovery (WHR) with carbon capture operations. By simultaneously managing process stream temperatures and generating power from recovered thermal energy, the disclosed technology offers comprehensive solutions for both thermal management and power consumption challenges. The system maintains optimal lithium-zirconate (LZO) operating temperatures while converting waste heat to electrical power through various thermodynamic cycles, including Brayton, Rankine, and thermoelectric generation. Applications span both stationary facilities and mobile implementations, enabling carbon capture while reducing overall system power requirements and improving operational efficiency.

### CROSS-REFERENCE TO RELATED APPLICATIONS

This application claims priority to U.S. Provisional Patent Application No. 63/749,759, filed January 27, 2025, the content of which is incorporated herein by reference in its entirety.

### FIELD

The present disclosure relates generally to carbon capture systems, and more particularly to systems and methods that integrate waste heat recovery with temperature control in carbon capture applications, including both stationary and mobile implementations.

### BACKGROUND

Carbon capture systems employ various mechanisms including adsorption, absorption, and physical or chemical separation to remove carbon dioxide (CO₂) from process streams. These capture mechanisms require specific temperature ranges for optimal performance, with efficiency and capture rates highly dependent on maintaining proper operating temperatures.

In industrial processes, CO₂ is typically generated through combustion or oxidizing chemical reactions, producing gas streams at temperatures significantly above optimal carbon capture conditions. This temperature mismatch creates two distinct challenges: first, the need to cool process streams to appropriate capture temperatures, and second, the substantial electrical power requirements for operating carbon capture system components such as pumps, compressors, and auxiliary equipment.

Conventional approaches use standard heat exchangers to cool process streams, but this method wastes potentially useful thermal energy. Additionally, the power requirements for carbon capture systems typically rely entirely on external electrical supply, increasing both operational costs and indirect carbon emissions through power consumption.

Therefore, there exists a need for systems and methods that can efficiently manage process stream temperatures while simultaneously reducing the power consumption of carbon capture systems.

### BRIEF SUMMARY

The present disclosure addresses this need by providing integrated systems and methods that combine waste heat recovery (WHR) with carbon capture operations. By simultaneously managing process stream temperatures and generating power from recovered thermal energy, the disclosed technology offers a comprehensive solution to both thermal management and power consumption challenges in carbon capture applications.

In accordance with one aspect of the present disclosure, a waste-heat recovery (WHR) system is combined with a carbon capture system to provide an optimal inlet temperature for the carbon capture system while simultaneously generating some, or all, of the power required to run the carbon capture system. The system is particularly effective for lithium-zirconate (LZO) based carbon capture applications, where maintaining temperatures between 550°C and 700°C is critical for optimal CO₂ transfer reactions.

The disclosed system employs various thermodynamic cycles, including Brayton or Rankine cycles, with working fluids such as supercritical CO₂, ethanol, or water, selected based on specific application requirements. Temperature control is achieved through a coordinated system of heat exchange, bypass flow, and auxiliary cooling, ensuring stable operation across varying process conditions, such as stationary applications, mobile applications, and thermoelectric generator (TEG) implementation.

In stationary applications, the system can significantly reduce facility Scope 2 emissions (the indirect greenhouse gas emissions associated with the energy an organization purchases and uses, such as electricity, steam, heat, or cooling) by generating power for carbon capture operations, with excess power available for export to the local grid.

For mobile applications, the system may integrate with hybrid powertrains, enabling carbon capture while potentially improving overall vehicle efficiency through waste heat utilization.

For TEG implementation, the system’s temperature management capabilities enable optimal thermal gradients across TEG modules while maintaining appropriate carbon capture operating temperatures, allowing direct conversion of waste heat into electrical power.

This integrated approach provides multiple benefits beyond conventional systems: reduced power consumption through self-generated electricity, optimized carbon capture efficiency through precise temperature control, and decreased overall carbon intensity of operations through improved energy utilization. The system’s adaptability to both stationary and mobile applications renders it particularly valuable for addressing carbon capture needs across diverse industrial and transportation sectors.

### BRIEF DESCRIPTION OF THE DRAWINGS

FIG. 1 illustrates an exemplary diagram of a waste heat recovery system for carbon capture, showing a heat exchanger for WHR system, an alternating current (AC) generator, a carbon capture system, and associated flow paths including a hot bypass.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure provides an innovative solution to two critical challenges in carbon capture technology: thermal management and power consumption. Prior approaches have treated these as separate problems, typically using conventional heat exchangers for cooling while drawing grid power for system operation. The present disclosure uniquely integrates waste heat recovery with carbon capture operations, simultaneously achieving temperature control for optimal capture conditions while generating electrical power from what would otherwise be wasted thermal energy. This dual-purpose approach significantly improves overall system efficiency and reduces operational costs while potentially enabling carbon capture in both mobile field applications and stationary generation applications.

For purposes of this disclosure, mobile field refers to internal combustion engine applications including, but not limited to, portable generators, backup residential generators, light-duty vehicles, on-off-road heavy-duty vehicles, locomotives, aircraft, and marine transport, but specifically excluding stationary generation. Stationary generation encompasses the use of one or more internal combustion engines at a stationary facility to generate electric power for industrial or commercial use. Stationary source refers to a source of CO₂ emissions at a stationary facility that does not originate from internal combustion engines, such as a fluid catalytic cracker or a boiler.

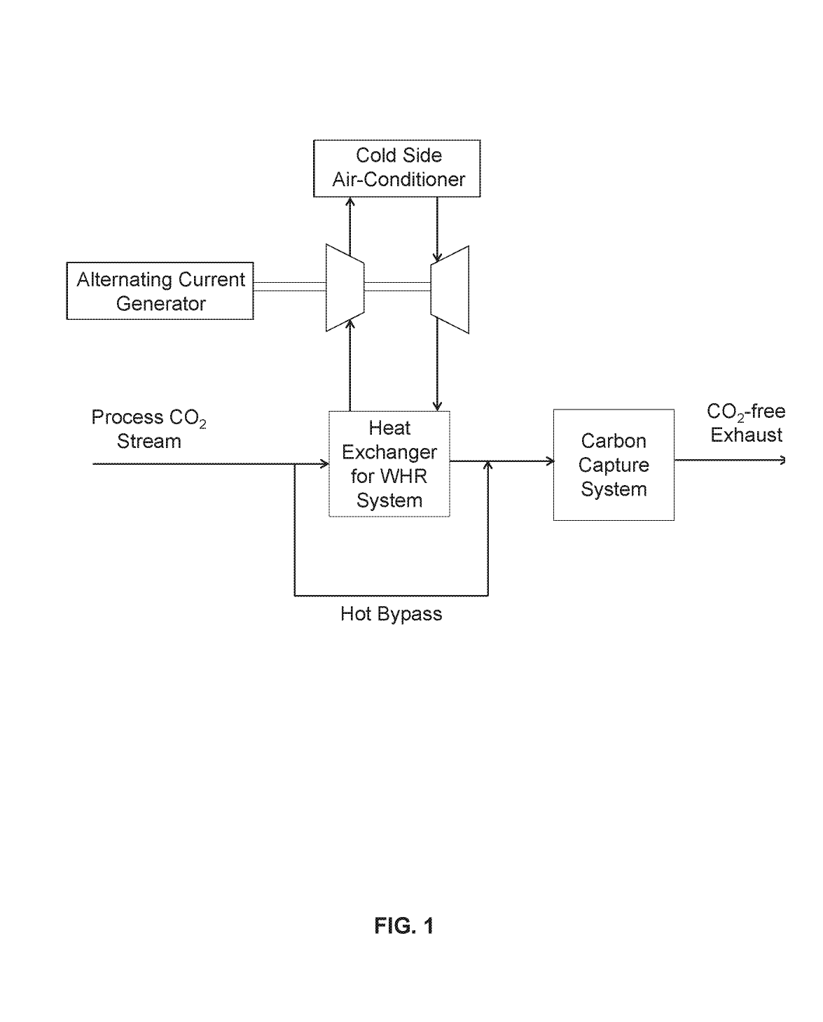

Accordingly, the present disclosure provides integrated systems and methods for waste heat recovery in carbon capture applications. By way of example, referring to FIG. 1 , an apparatus for waste-heat recovery and temperature control includes a heat exchanger for WHR system configured to receive a CO₂-containing process stream. An expander device couples to the heat exchanger and extracts thermal energy from the process stream. An AC generator mechanically couples to the expander device, converting the extracted thermal energy into electrical power. A temperature control system regulates the process stream temperature to within a lithium-zirconate (LZO) operating range of 550°C to 700°C. The system includes an outlet that delivers the temperature-regulated process stream to an LZO-based carbon capture system.

The temperature control system employs multiple mechanisms to maintain optimal process conditions. As shown in FIG. 1, a hot bypass channel routes a portion of the process stream around the heat exchanger. Additionally, a cold side air-conditioning unit provides auxiliary cooling capacity, working in conjunction with the primary temperature control system to ensure precise temperature management.

The apparatus can utilize either a Brayton thermodynamic cycle or a Rankine thermodynamic cycle. The working fluid circuit may employ supercritical carbon dioxide, ethanol, water, or combinations thereof, selected based on optimal thermal properties within the 550°C to 700°C temperature range. Flow control devices regulate heat extraction rates to maintain optimal system performance.

In stationary applications, the AC generator connects to a power grid, and the generated electrical power feeds back into the grid. For mobile applications, the generator connects to a vehicle’s battery, with generated power either charging the battery or providing motive power to the vehicle.

As illustrated in FIG. 1, a mixing section downstream of the heat exchanger combines the bypassed portion with the heat-exchanger-processed portion. Temperature sensors monitor stream conditions before and after mixing, while automated controls adjust bypass flow based on sensor readings to maintain the mixed stream temperature within the LZO operating range of 550°C to 700°C.

The temperature control system incorporates sensors at multiple locations: upstream of the heat exchanger to measure initial process stream temperature, downstream to measure processed stream temperature, and at the outlet to verify temperature compliance with LZO operating requirements. Control logic maintains outlet temperature between 550°C and 700°C, optimizes CO₂ transfer reactions in the LZO-based capture unit, and prevents thermal damage to the LZO medium.

A power management system measures electrical power generated from the extracted thermal energy and monitors power requirements of the LZO-based carbon capture system. In stationary implementations, excess power routes to a local power grid. For mobile implementations, excess power feeds a vehicle battery system via a rectifier to direct current.

The heat exchanger comprises multiple stages configured to provide controlled temperature reduction from above 700°C to the LZO operating range. These stages optimize heat extraction efficiency while maintaining stable thermal conditions for LZO-based CO₂ capture.

For system-level implementation, the waste heat recovery system integrates with a carbon capture unit comprising an LZO-based capture medium. As shown in FIG. 1, the WHR apparatus positions upstream of the carbon capture system and serves two primary functions: cooling the CO₂-containing gas stream to the optimal temperature range of 550°C to 700°C and generating electrical power from the recovered heat. This generated power at least partially powers the carbon capture system, reducing external power requirements.

In stationary carbon capture applications, the WHR apparatus shown in FIG. 1 includes the expander coupled to the AC generator, which connects to a local power grid. The system selectively directs the generated electrical power in multiple ways: powering the carbon capture system directly, supplying power to the local grid, or distributing power between the carbon capture system and grid based on operational requirements.

The control system for stationary implementations continuously monitors power consumption of the carbon capture unit and measures electrical power generated by the WHR apparatus. It dynamically allocates the generated power between the carbon capture unit and the local power grid based on several parameters: carbon capture unit power demands, local grid power demands, and facility power optimization requirements.

For mobile carbon capture applications, the WHR apparatus may integrate with a vehicle powertrain. For instance, referring to FIG. 1, the AC generator supplies power to an onboard battery system, which can selectively power either the carbon capture unit or vehicle propulsion systems. In hybrid powertrain vehicles, the WHR apparatus serves multiple functions: maintaining CO₂-containing exhaust gas temperature within the optimal LZO capture range, supplementing vehicle electrical power requirements, and reducing overall vehicle fuel consumption.

For thermoelectric generator (TEG) applications, the system’s temperature management capabilities enable optimal thermal gradients across TEG modules while maintaining appropriate carbon capture operating temperatures. Using the Seebeck effect, the TEG modules directly convert the temperature differential between the hot process stream and cooled output into electrical power. The system achieves this through precise temperature control of both the hot and cold sides of the TEG modules, while simultaneously maintaining the process stream within the required 550°C to 700°C range for LZO-based carbon capture. This integration provides several benefits including reduced system complexity due to solid-state operation, lower maintenance requirements compared to turbine-based systems, and reliable power generation for carbon capture auxiliary equipment. In mobile applications, the TEG implementation is particularly advantageous where space constraints and vibration resistance are critical factors, enabling both effective carbon capture and continuous power generation without additional mechanical complexity.

The method of operating the carbon capture system begins with receiving a CO₂-containing gas stream at the heat exchanger shown in FIG. 1. The WHR apparatus processes this stream to achieve dual objectives: adjusting the gas stream temperature to between 550°C and 700°C for optimal LZO-based carbon capture and generating electrical power from the extracted thermal energy. The temperature-controlled gas stream then flows to the LZO-based carbon capture unit.

The generated electrical power primarily powers the carbon capture unit, with excess power handled differently depending on the application. In stationary applications, excess power feeds into the local grid, while in mobile applications, the excess power stores in the vehicle battery system for later use.

The operation requires continuous monitoring of the gas stream temperature entering the LZO-based capture unit. As shown in FIG. 1, the system adjusts WHR apparatus operation through the bypass line and cold side air-conditioning to maintain the gas stream temperature between 550°C and 700°C. Meanwhile, the system measures power generation and optimizes its distribution between carbon capture unit operation, local grid supply in stationary applications, and vehicle power requirements in mobile applications.

### EXAMPLES

The following examples are offered to illustrate provided embodiments and are not intended to limit the scope of the present disclosure.

A stationary facility implementation processes CO₂-containing streams from a fluid catalytic cracker (a processing unit in a petroleum refinery) through the disclosed system. The process stream enters the heat exchanger at 800°C and is successfully controlled to 600°C at the carbon capture system inlet. The AC generator produces 500 kW of continuous power, offsetting 80% of the carbon capture system power requirements while maintaining temperature control within ±3°C of the setpoint. The system achieves 98% availability during extended operation.

A mobile implementation integrates the disclosed system with a heavy-duty transport vehicle’s hybrid powertrain. The exhaust gas entering the heat exchanger at 750°C is consistently maintained at 600°C for optimal capture performance. The AC generator produces variable power output between 25 and 75 kW, fully powering the carbon capture system while providing supplemental power for vehicle propulsion. This integration reduces overall fuel consumption by 8% during optimal operation.

Temperature control performance is demonstrated under varying input conditions using the disclosed system configuration. With input temperatures ranging from 700°C to 900°C and flow rate variations of up to 30%, the system maintains output temperature within the required 550°C to 700°C range. The coordinated operation of the heat exchanger, hot bypass, and cold side air-conditioner achieves temperature stability within ±3°C during steady-state operation.

Taken together, the examples demonstrate successful applications across both mobile and stationary implementations. In mobile field scenarios, the disclosed system enables carbon capture from moving sources while potentially improving vehicle efficiency through power recovery. For stationary generation facilities, the technology can offset power consumption of carbon capture systems while optimizing capture efficiency. In stationary source applications, the system can handle high-temperature process streams from various industrial operations while reducing both direct CO₂ emissions and indirect emissions from power consumption. The disclosed technology is capable of handling varying process conditions and contributing to overall system efficiency and reduced carbon intensity.

.

What is claimed is:

1. An apparatus for waste-heat recovery (WHR) and temperature control for lithium-zirconate (LZO) based carbon capture, the apparatus comprising:
a heat exchanger configured to receive a CO₂-containing process stream;
an expander device coupled to the heat exchanger and configured to extract thermal energy from the process stream;
a generator mechanically coupled to the expander device and configured to convert the extracted thermal energy into electrical power;
a temperature control system configured to regulate process stream temperature to within an LZO operating range of 550°C to 700°C; and
an outlet configured to deliver the temperature-regulated process stream to an LZO-based carbon capture unit.

2. The apparatus of claim 1, further comprising a bypass channel configured to route at least a portion of the process stream around the heat exchanger.

3. The apparatus of claim 1, wherein apparatus utilizes a Brayton thermodynamic cycle or a Rankine thermodynamic cycle.

4. The apparatus of claim 1, wherein the apparatus uses a working fluid of supercritical carbon dioxide, ethanol, and/or water.

5. The apparatus of claim 1, wherein the generator is connected to a power compressor for the CO₂ compression system.

6. The apparatus of claim 1, wherein the generator is connected to a power grid and the generated electrical power is fed back into the power grid.

7. The apparatus of claim 1, wherein the generator is connected to a vehicle’s battery and the generated electrical power is fed back into the vehicle’s battery to provide motive power to the vehicle.

8. The apparatus of claim 1, further comprising:
a mixing section downstream of the heat exchanger configured to combine the bypassed portion with the heat-exchanger-processed portion and maintain mixed stream temperature within the LZO operating range of 550°C to 700°C;
temperature sensors positioned to monitor stream temperature before and after mixing; and/or
automated controls to adjust bypass flow based on temperature sensor readings.

9. The apparatus of claim 1, wherein the temperature control system comprises:
temperature sensors positioned:
upstream of the heat exchanger to measure initial process stream temperature;
downstream of the heat exchanger to measure processed stream temperature; and/or
at the outlet to verify temperature compliance with LZO operating requirements;
control logic configured to:
maintain outlet temperature between 550°C and 700°C;
optimize CO₂ transfer reactions in the LZO-based capture unit; and/or
prevent thermal damage to the LZO medium.

10. The apparatus of claim 1, further comprising a working fluid circuit configured for LZO temperature requirements, including:
a working fluid selected based on optimal thermal properties within the 550°C to 700°C range; and/or
flow control devices to regulate heat extraction rates.

11. The apparatus of claim 1, further comprising a power management system configured to:
measure electrical power generated from the extracted thermal energy;
monitor power requirements of the LZO-based carbon capture unit;
supply power to the LZO-based carbon capture unit; and/or
route excess power to:
a local power grid in stationary implementations; or
a vehicle battery system in mobile implementations.

12. The apparatus of claim 1, wherein the heat exchanger comprises multiple stages configured to:
provide controlled temperature reduction from above 700°C to the LZO operating range;
optimize heat extraction efficiency within each temperature stage; and/or
maintain stable thermal conditions for LZO-based CO₂ capture.

13. Use of the apparatus of claim 1 for waste-heat recovery and temperature control for carbon capture.

14. A waste heat recovery system for carbon capture comprising:
a carbon capture unit comprising a lithium-zirconate (LZO) based capture medium;
a waste heat recovery (WHR) apparatus upstream of the carbon capture unit configured to:
cool a CO₂-containing gas stream to a temperature range of 550°C to 700°C for optimal LZO capture performance; and/or
generate electrical power from the recovered heat;
wherein the generated electrical power is used to at least partially power the carbon capture unit.

15. A stationary carbon capture system comprising the system of claim 14, wherein:
the WHR apparatus comprises an expander coupled to an electrical generator;
the electrical generator is connected to a local power grid; and
the generated electrical power is selectively:
used to power the carbon capture unit;
supplied to the local power grid; and/or
distributed between the carbon capture unit and the local power grid.

16. The stationary system of claim 15, further comprising a control system configured to:
monitor power consumption of the carbon capture unit;
measure electrical power generated by the WHR apparatus; and/or
dynamically allocate the generated power between the carbon capture unit and the local power grid based on:
carbon capture unit power demands;
local grid power demands; and/or
facility power optimization parameters.

17. A mobile carbon capture system comprising the system of claim 14, wherein:
the WHR apparatus is integrated with a vehicle powertrain;
the generated electrical power is supplied to an onboard battery system; and
the battery system is configured to selectively power the carbon capture unit, and/or vehicle propulsion.

18. The mobile system of claim 17, wherein the vehicle comprises a hybrid powertrain; and
the WHR apparatus is configured to:
maintain CO₂-containing exhaust gas temperature within the optimal LZO capture range;
supplement vehicle electrical power requirements; and/or
reduce overall vehicle fuel consumption.

19. A method of operating a carbon capture system comprising:
receiving a CO₂-containing gas stream;
passing the gas stream through a waste heat recovery (WHR) apparatus to adjust the gas stream temperature to between 550°C and 700°C for optimal LZO-based carbon capture and to generate electrical power from the extracted thermal energy;
directing the temperature-controlled gas stream to an LZO-based carbon capture unit;
powering the carbon capture unit using the generated electrical power; and selectively:
in a stationary application, supplying excess generated power to a local grid; or
in a mobile application, storing excess generated power in a vehicle battery system.

20. The method of claim 19, further comprising:
monitoring the gas stream temperature entering the LZO-based capture unit;
adjusting WHR apparatus operation to maintain the gas stream temperature between 550°C and 700°C;
measuring power generation from the WHR apparatus; and
optimizing power distribution between:
carbon capture unit operation;
local grid supply in stationary applications; and
vehicle power requirements in mobile applications.
